(19) United States
(12) Patent Application Publication
(10) Pub. No.: US 2016/0007245 A1
(43) Pub. Date: Jan. 7, 2016

(54) Methods and Devices for Managing a Cellular Radio Network

(71) Applicant: TELEFONAKTIEBOLAGET L M ERICSSON(PUBL), Stockholm (SE)

(72) Inventors: Qingyu MIAO, Beijing (CN); Xinyu GU, Beijing (CN); Zhang ZHANG, Beijing (CN)

(21) Appl. No.: 14/769,986

(22) PCT Filed: Feb. 25, 2013
(86) PCT No.: PCT/CN2013/071817

§ 371 Date: Aug. 24, 2015

(51) Int. Cl. H04W 36/00

(52) U.S. Cl. CPC H04W 36/0055

(57) ABSTRACT

In a radio system information is transmitted from a network node to a UE informing the UE about a dedicated pilot signal used in a combined cell when a handover of a User Equipment is performed from a first combined cell to a second combined cell.

### TECHNICAL FIELD

The present disclosure relates to methods and devices for managing a cellular radio network.

### BACKGROUND

Cellular radio networks allow for mobile communication all over the world. In some deployments of a cellular radio networks a so-called Combined Cell is configured. Combined Cell allows the operator to configure multiple transceivers with partially overlapping coverage where the multiple transmitters utilize the same carrier signal. The same downlink signal is then transmitted from each transmitter in the downlink, and the uplink signal is combined from the different transceivers. In other words the signal from one radio base station is transmitted/ received via multiple uplinks/downlinks to spatially separated transmitters/receivers on the network side. Typically a Combined Cell configuration is employed to cover blind spots underneath a macro sector, or to reduce the required number of separate cell carriers for covering a larger area, see also. Third Generation Partnership Project (3GPP) TSG RAN WG1 Meeting #71 R1-125220, Combined Cell Deployment Scenarios in Heterogeneous Networks, New Orleans, USA, 12-16 Nov. 2012.

One typical scenario where combined cell can be used is when a Remote radio Unit (RRU) is combined with a macro sector, which can be deployed in blind spots or outdoor hot spots near macro cells. Another typical scenario where combined cell can be used is in a scenario with limited coverage, such as high mobility (railways).

Compared to separate cells, the combined cell can have fewer cells controlled by the Radio Network Controller /Operations Support System RNC/OSS, less mobility signaling, and it can have smooth cell split if traffic increases.

In some cases, one or many of the multiple transceivers can be muted to reduce inter-cell interference. In other scenarios different signals to different UE can be transmitted from different transceivers using the same radio resource when there is large spatial isolation, which can get spatial reuse gain. The spatial isolation can be measured from uplink.

Handover Procedure

In FIG. 3 a handover procedure in a Wideband Code Division Multiple Access (WCDMA) radio network is generally depicted. A more detailed description of the handover procedure is found in 3GPP Technical Specification (TS) 25.331. The signaling in handover procedure mainly includes:
UMTS Terrestrial Radio Access Network (UTRAN) informs a User Equipment (UE) of neighboring cell information
UE measures Common Pilot Channel (CPICH) power and time delay from adjacent cells
UE reports measurements to UTRAN
UTRAN decides the handover strategy
Radio Network Controller (RNC) informs the target cell to “radio link setup”
Target cell starts Receiving (RX) and response “radio link setup proceed”
After synchronization, target cell starts the Transmission(TX),
UTRAN informs UE the “active set update command”
UE starts RX and responds with “active set update complete”

There is a constant desire to improve performance in cellular radio networks.

Hence, there is a need for a method and an apparatus that provide an improved utilization of resources in a cellular radio network, in particular a WCDMA radio network.

### SUMMARY

It is an object of the present invention to provide an improved method and apparatus for improving utilization of resources in a cellular radio network, in particular a WCDMA radio network.

This object and others are obtained by the method and device as set out in the appended claims.

As has been realized by the inventors in a combined cell, the Primary CPICH is used for mobility measurement, and the dedicated pilot signal can be used for the data demodulation for future UEs. In other words Combined cell might be a new feature in Release 12. The futures UEs can follow release 12 requirements. After handover from a combined cell, the UE may switch to another dedicated pilot signal in a target combined cell for data demodulation. In accordance with some embodiments signaling is used to support the switch from one combined cell to another combined cell. Further, the dedicated pilot could use different scramble code from the scramble code for Primary CPICH.

In accordance with some embodiments a method in a network node of a cellular radio network, such as a WCDMA network, is provided. When a handover of a User equipment from a first combined cell to a second combined cell is performed information is transmitted from a network node to the UE informing the UE about a dedicated pilot signal used in the second combined cell. Hereby an improved handover can be achieved. In accordance with some embodiments the information to the UE about the dedicated pilot signal used in the second combined cell is transmitted from the serving Radio Network Controller during the handover. In some alternative embodiments the information to the UE about the dedicated pilot signal used in the second combined cell is transmitted from a node in the second combined cell after the handover.

The disclosure also extends to devices, such as User Equipments and network nodes for use in a cellular radio system adapted to perform the methods as described herein. The devices can be provided with a controller/controller circuitry for performing the above processes. The controller(s) can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

### BRIEF DESCRIPTION OF THE DRAWINGS

The present invention will now be described in more detail by way of non-limiting examples and with reference to the accompanying drawings, in which:

FIG. 1 is a general view of a cellular radio network,

FIG. 2 is a view of a cell configured as a combined cell,

FIG. 3 depicts a handover procedure,

FIG. 4 depicts a modified handover procedure in accordance with a first embodiment, and

FIG. 5 depicts a modified handover procedure in accordance with a second embodiment,

FIG. 6 is a view of a User Equipment,

FIG. 7 is a view of a radio base station, and

FIG. 8 is a view of a central node.

### DETAILED DESCRIPTION

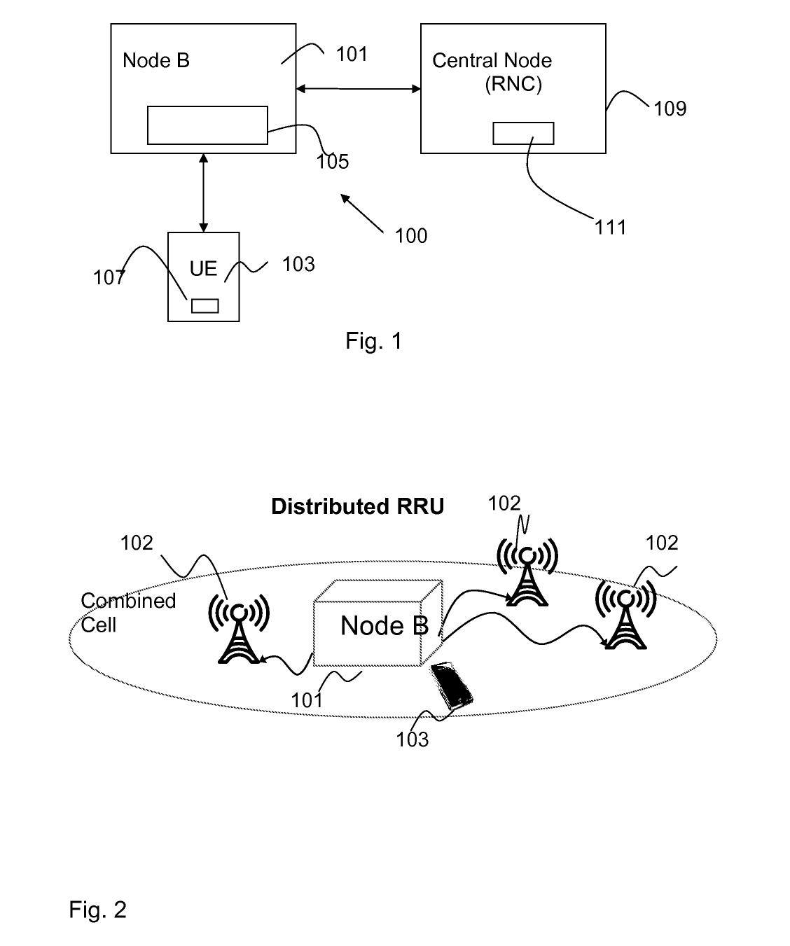

In FIG. 1 a general view of a cellular radio network 100 is depicted. The system can for example be a WCDMA system. The network 100 comprises a number of radio base stations 101, here denoted NodeBs, whereof only one is shown in the simplified view in FIG. 1. The radio base stations 101 are connected to a central control node denoted Radio Network controller (RNC) 109. The network 100 may of course comprise multiple RNCs. The RNC 109 further comprises a module 111 for performing different operations of the radio base station 109. Mobile stations 103, here represented by a single unit and denoted User Equipment (UE), that are present in a geographical area covered by the radio base station can connect to the radio base station over an air-interface. The radio base station 101 further comprises a module 105 for performing different operations of the radio base station 101. In particular the radio base stations may be configured as combined cell. The module 105 can for example be implemented using a microcontroller operating on a set of computer software instructions stored on a memory in the module 105. The UEs 103 in turn comprises a module 107 adapted to perform operations of the UEs 103. The module 107 can for example be implemented using a microcontroller operating on a set of computer software instructions stored on a memory in the module 107. The NodeB supports transmission to and from all the UEs in the area that it covers.

FIG. 2 depicts a cell configured as a combined cell. In a combined call, the radio base station Node B 101 transmits and receives the same data to/from a UE 103 via multiple uplinks/downlinks to spatially separated transmitters/receivers 102.

When the UE handovers from one combined cell to another combined cell, the demodulation of the received data can be handled in different manners.

### First Example: Switch to a Dedicated Pilot Signal Directly

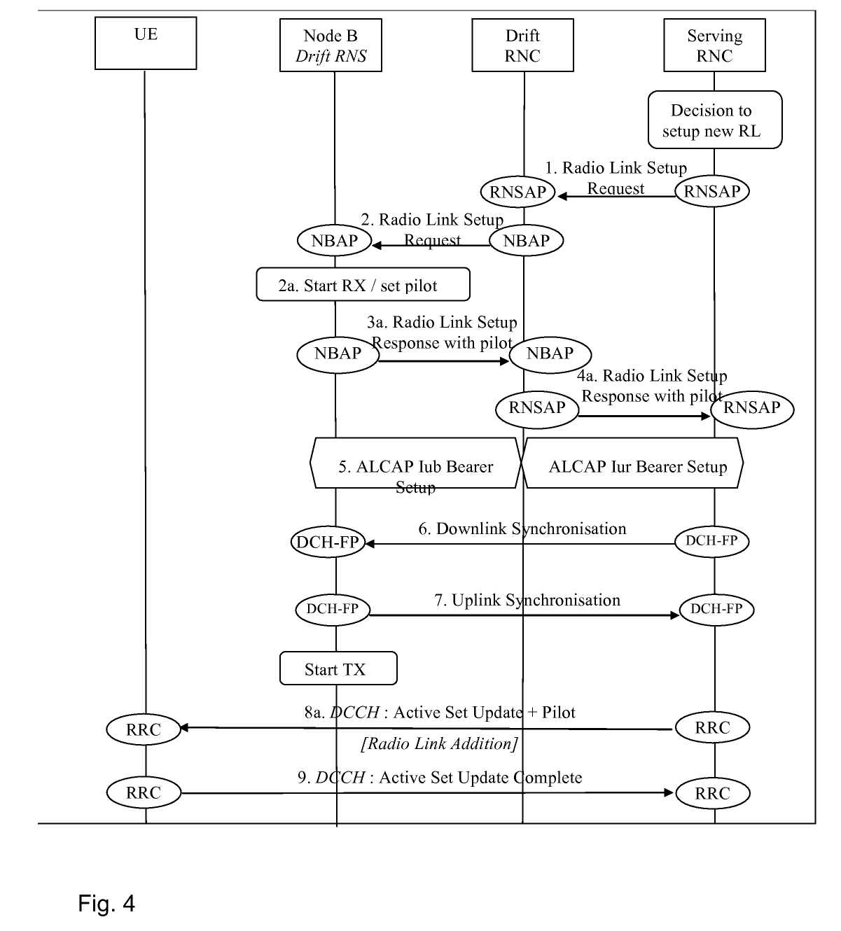

In accordance with some embodiments a direct switch to a dedicated pilot signal in the target combined cell can be performed as depicted in FIG. 4.

First, the UTRAN informs UE of the neighboring cell information. Next the UE measures CPICH power and time delay from adjacent cells. Then the UE reports measurements to

UTRAN. Then the UTRAN decides the handover strategy. These steps correspond to existing mechanisms for handover as described herein above.

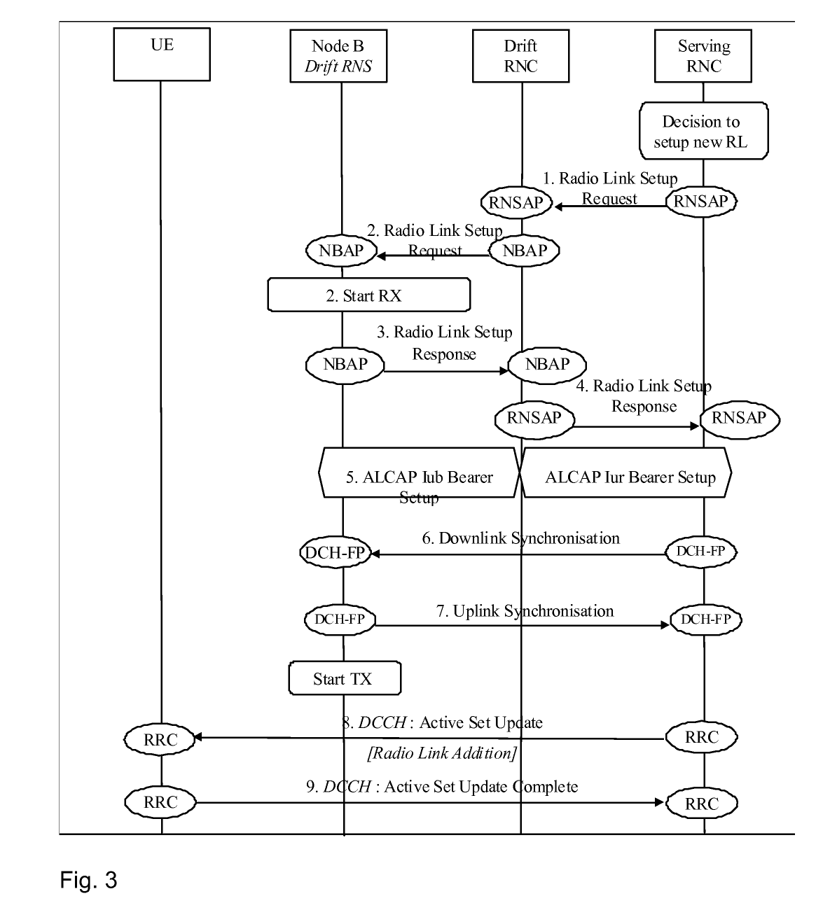

In FIG. 4 a handover procedure which corresponds to FIG. 3, but where some procedural steps have been altered to provide for a direct switch to a dedicated pilot signal is depicted.

In accordance with embodiments of FIG. 4 the RNC informs the target cell to “radio link setup” step 1 and step 2. The target cell starts receiving RX, and decides which dedicated pilot signal to use step 2a, and responds with radio link setup response steps 3a and 4a together with dedicated pilot information.

After synchronization, target cell starts transmission using the dedicated pilot signal, the transmission of the downlink signal can take place using some or all of the different transmit antennas available for downlink transmission.

Then the serving Radio Network Controller (RNC) of the UTRAN informs UE the “active set update” in a step 8a. The “active set update” message also comprises information about the dedicated pilot signal of the target cell.

Finally, the UE starts receiving and responds with “active set update complete”. The UE now has knowledge about the dedicated pilot signal of the target cell.

### Second Example Switch to Common Pilot First and then Switch to Dedicated Pilot

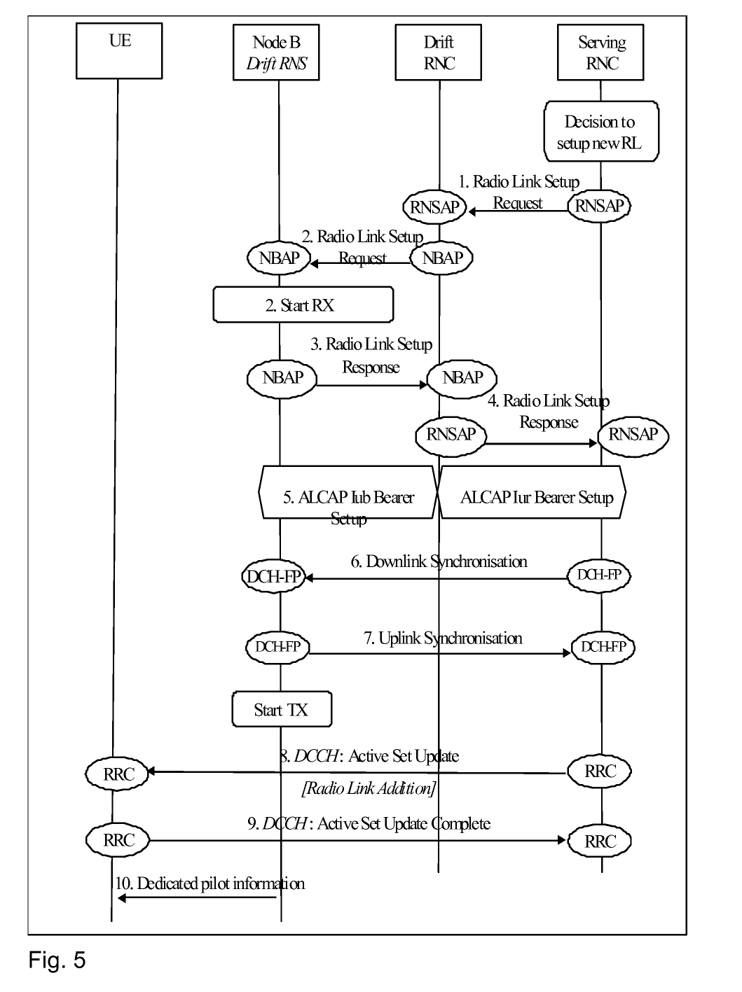

In accordance with some embodiments a switch to common pilot first and then switch to a dedicated pilot signal in the target combined cell can be performed as depicted in FIG. 5.

First, the UTRAN informs UE of the neighboring cell information. Next the UE measures CPICH power and time delay from adjacent cells. Then the UE reports measurements to UTRAN. Then the UTRAN decides the handover strategy. These steps correspond to existing mechanisms for handover as described herein above.

In FIG. 5 a handover procedure which corresponds to FIG. 3, but where some procedural steps have been altered to provide for a switch to a dedicated pilot signal is depicted. In accordance with embodiments of FIG. 5 the RNC informs the target cell to “radio link setup” step 1 and step 2. The target cell starts receiving RX, and responds with radio link setup response steps 3 and 4.

After synchronization steps 6 and 7, the target cell starts the transmission TX, and the UTRAN informs the UE using the “active set update ” in step 8 and the UE starts receiving RX and responds with “active set update complete” in a step 9.

Then in a step 10, the target combined cell informs the UE the information of the dedicated pilot, and starts to transmit the data with dedicated pilot using some (or all) of the antennas available for downlink transmission.

In accordance with some embodiments, when the UTRAN informs UE of the neighboring cell information, the neighbor cell information can be different for different UEs since the UE uses different dedicated pilot and rough position can be know by UTRAN. In other words the neighbor cell information can be user specific and instead of cell specific.

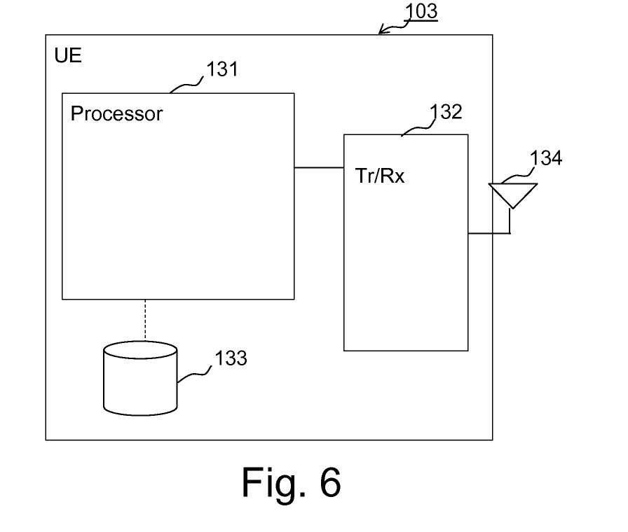

In FIG. 6, an exemplary UE 103 adapted to perform handover in accordance with the above methods is depicted. The example UE 103 includes a processor 131, a memory 133, a transceiver 132, and an antenna 134. In particular embodiments, some or all of the functionality described above as being provided by mobile communication devices or other forms of mobile station may be provided by the mobile station processor 131 executing instructions stored on a computer-readable medium, such as the memory 133 shown in FIG. 6. Alternative embodiments of the mobile station may include additional components beyond those shown in FIG. 6 that may be responsible for providing certain aspects of the mobile station's functionality, including any of the functionality described above and/or any functionality necessary to support the solution described above.

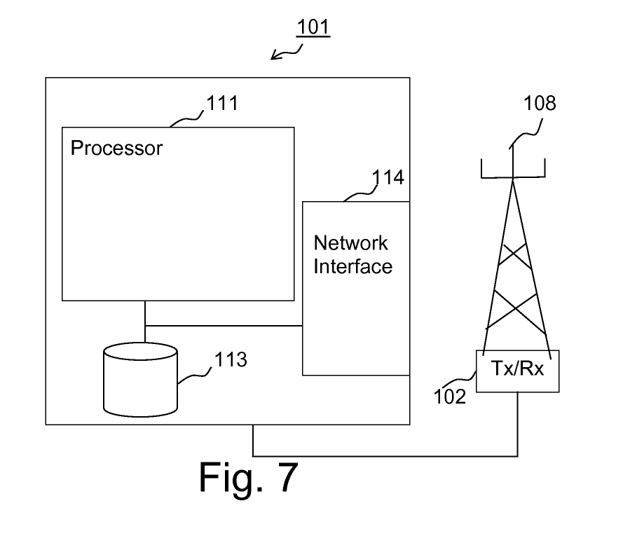

In FIG. 7 an exemplary radio base station 101 is shown. As shown in FIG. 7, the example radio base station 101 includes a processor 111, a memory 113, at transceiver 102, and an antenna 108 representing the multiple antennas described above. The example radio base station can also comprise a network interface 114. In particular embodiments, some or all of the functionality described above as being provided by a radio base station, may be provided by the radio base station processor executing instructions stored on a computer-readable medium, such as the memory 113 shown in FIG. 7. Alternative embodiments of the base station may include additional components responsible for providing additional functionality, including any of the functionality identified above and/or any functionality necessary to support the solution described above.

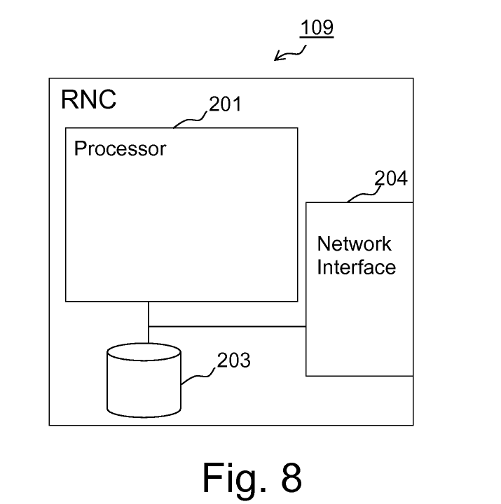

Further, FIG. 8 depicts an exemplary central node 109, such as an RNC. The example central node 20 includes a processor 201, a memory 203, and a network interface 204 for connection to other nodes of a cellular network such as a base station. In particular embodiments, some or all of the functionality described above as being provided by a central node, may be provided by the processor 201 executing instructions stored on a computer-readable medium, such as the memory 203.

Using the methods and devices as described herein will provide a more efficient handover in when a UE is handed over form one combined cell to another combined cell.

1-16. (canceled)

17. A method in a network node of a cellular radio network when performing a handover of a user equipment (UE) from a first combined cell to a second combined cell, the first and second combined cells each comprising spatially separated transceivers, the method comprising,
transmitting information from the network node to the UE informing the UE about a dedicated pilot signal used in the second combined cell.

18. The method of claim 17, wherein the information to the UE about the dedicated pilot signal used in the second combined cell is transmitted from the serving Radio Network Controller during the handover.

19. The method of claim 17, wherein the information transmitted to the UE about the dedicated pilot signal used in the second combined cell is transmitted from a node in the second combined cell, after the handover.

20. The method of claim 17, wherein the cellular radio network is a Wideband Code Division Multiple Access (WCDMA) radio network.

21. A network node of a cellular radio network adapted to perform a handover of a user equipment (UE) from a first combined cell to a second combined cell, the first and second combined cells each comprising spatially separated transceivers, the node comprising controller circuitry adapted to transmit information from the network node to the UE informing the UE about a dedicated pilot signal used in the second combined cell.

22. The network node of claim 21, wherein the network node is adapted to inform the UE about the dedicated pilot signal used in the second combined cell during the handover.

23. The network node of claim 21, wherein the network node is adapted to inform the UE about the dedicated pilot signal used in the second combined cell after the handover.

24. The network node of claim 21, wherein the cellular radio network is a Wideband Code Division Multiple Access (WCDMA) radio network.

25. A method in a user equipment adapted to be connected to a cellular radio network when performing a handover from a first combined cell to a second combined cell of the cellular radio network, the first and second combined cells each comprising spatially separated transceivers, the method comprising,
receiving information from a network node informing the UE about a dedicated pilot signal used in the second combined cell.

26. The method of claim 25, wherein the information to the UE about the dedicated pilot signal used in the second combined cell is received from the serving Radio Network Controller during the handover.

27. The method of claim 25, wherein the information received from the network node about the dedicated pilot signal used in the second combined cell is received from a node in the second combined cell after the handover.

28. The method of claim 25, wherein the cellular radio network is a Wideband Code Division Multiple Access (WCDMA) radio network.

29. A user equipment (UE) adapted to connect to a cellular radio network and to perform a handover from a first combined cell to a second combined cell in said cellular radio network, the first and second combined cells each comprising spatially separated transceivers, the UE comprising controller circuitry adapted to receive information from a network node informing the UE about a dedicated pilot signal used in the second combined cell.

30. The UE of claim 29, wherein the UE is adapted to receive information about the dedicated pilot signal used in the second combined cell during the handover.

31. The UE of claim 29, wherein the UE is adapted to receive information about the dedicated pilot signal used in the second combined cell after the handover.

32. The UE of claim 29, wherein the cellular radio network is a Wideband Code Division Multiple Access (WCDMA) radio network.
